(19) United States
(12) Patent Application Publication
(10) Pub. No.: US 2008/0099479 A1
(43) Pub. Date: May 1, 2008

(54) DAMAGE INDICATION SYSTEMS AND METHODS

(76) Inventor: Calvin Y. Liu, Irvine, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/554,947

(22) Filed: Oct. 31, 2006

(51) Int. Cl. B65D 55/02; B32B 33/00; G08B 13/14

(52) U.S. Cl. 220/214; 428/40.1; 340/568.1

(57) ABSTRACT

Systems and methods for detecting damage to a device are disclosed. In accordance with an embodiment of the present invention, a device includes a housing with one or more visual damage detection elements. The visual damage detection elements provide a visual indication if the housing is subjected to a force greater than a threshold level.

### TECHNICAL FIELD

The present invention relates generally to systems and methods for providing a damage indication and more particularly to determining device damage that exceeds a specified limit, such as for example to portable electronic devices subjected to damage exceeding warranty limits.

### BACKGROUND

The number and variety of electronic devices available to the consumer has proliferated considerably. A partial list of such devices may include pagers, cell phones, personal digital assistants (PDAs), MPEG-1 Audio Layer 3 (MP3) players, the Ipod®, Global Positioning System (GPS) receivers, digital video (DV) players, and laptop and notebook computers. These products are often carried and employed under a wide variety of conditions, sometimes when the user is engaged in more than one activity. It is not uncommon for these consumer products to be dropped or otherwise damaged internally and no longer function.

While industrial design practices generally incorporate a degree of margin to accommodate an expected level of shock or minor abuse, it may happen that more severe abuse of the device takes place that is not covered, for example, by the manufacturer's warranty for repair or replacement. Detecting whether this has happened is difficult to determine after the fact, because external appearances may not accurately reflect the level of internal damage.

For example, packaging technology has advanced to the degree that the outer housing may withstand serious abuse, but forces transmitted internally to the product result in disabling damage, such as broken solder joints, damaged printed circuit boards, damaged integrated circuits, dislodged discreet components, or torn ribbon cables. Typically, the retailer cannot determine if the customer use exceeded warranty coverage for minor abuse. Thus, the device is shipped back to the manufacturer for diagnostics, which adds significant costs and time for the retailer and manufacturer.

As a result, there is a need to provide systems and methods to enable, for example, the retailer or manufacture to determine if a specified limit of force (e.g., stress or abuse) to the device has been exceeded.

### SUMMARY

Systems and methods are disclosed herein in accordance with one or more embodiments of the present invention to provide detection of a specified level of damage-inducing stress to a device. For example, in accordance with an embodiment of the present invention, a visual damage detection element is disclosed which may be strategically incorporated into the external housing of a product at one or more locations. Under excessive stress, vibration, shock or compression, the structural damage detection element fails or is altered in such a way as to disclose that a damage limit to the device has been exceeded.

In accordance with an embodiment of the present invention, a visual damage detection element may be made of a material of suitable brittleness, shape, and/or variable thickness and mounted to the product housing or otherwise formed as part of or incorporated into the housing to be sensitive to components of shear and compressive force, as well as high frequency vibration that can cause excessive low displacement/very high acceleration forces to internal components.

In accordance with an embodiment of the present invention, the visual damage detection element may be color-coded to identify what levels of stress the product may be subjected to and remain within warranty coverage limitations. For example, failure of the visual damage detection element generally indicates that the indicated stress level has been exceeded.

In accordance with an embodiment of the present invention, the visual damage detection element may be configured, as one or more integral portions of the housing, to fail when a specified stress limit has been exceeded.

In accordance with an embodiment of the present invention, the visual damage detection element may incorporate micro-capsules configured to fail under sufficient stress and release a dye or other chemical that alters the appearance or color of the visual damage detection element as an indicator that a specified stress limit has been exceeded.

In accordance with an embodiment of the present invention, the visual damage detection element may incorporate a range of microcapsules configured to fail at different levels of stress as a result of the capsule design, and thus release dyes of different color to indicate the maximum level of stress that occurred leading to failure of the device. This provides a quantitative measure of the level of stress resulting in failure of the product.

In accordance with one or more embodiments of the present invention, the visual damage detection element may be installed as part of the device housing with a cover to provide protection from damage occurring exclusively to the visual damage detection element, but not to the product. For example the visual damage detection element may be protected to perform its intended function, as well as to provide a cosmetic cover, if desired.

More specifically in accordance with an embodiment of the present invention, a device includes a housing; and a visual damage detection element, coupled to the housing, adapted to provide a visual indication if the housing is subjected to a force greater than a first threshold.

In accordance with another embodiment of the present invention, a device includes a housing; and means for providing a visual indication if the housing is subjected to a force greater than a first threshold.

In accordance with another embodiment of the present invention, a method comprises providing a housing for a device; selecting a visual damage detection element based on a level of force that may be applied to the device; and coupling the visual damage detection element to the housing during assembly of the device.

In accordance with another embodiment of the present invention, a method comprises inspecting a visual damage detection element of a device, wherein the visual damage detection element provides a visual indication if the device is subjected to a force greater than a certain level; and determining if the device was subjected to a force greater than the certain level based upon the inspecting.

The scope of the invention is defined by the claims, which are incorporated into this section by reference. A more complete understanding of embodiments of the present invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 is an illustration of various hand-held portable electronic products in accordance with one or more embodiments of the present invention.

FIGS. 2a and 2b show front and side perspective views, respectively, of a portable device (e.g., a cell phone) incorporating visual damage detection elements in accordance with an embodiment of the present invention.

FIG. 3 shows visual damage detection elements incorporated into various locations of a portable device (e.g., a laptop computer) in accordance with one or more embodiments of the present invention.

FIGS. 4a-e show views of specific examples of a visual damage detection element in accordance with one or more embodiments of the present invention.

FIG. 5 shows an example of a visual damage detection element providing visible damage evidence in accordance with an embodiment of the present invention.

FIGS. 6a-6b show specific examples of visual damage detection elements providing visible damage evidence in accordance with one or more embodiment of the present invention.

Embodiments of the present invention and their advantages are best understood by referring to the detailed description that follows. It should be appreciated that like reference numerals are used to identify like elements illustrated in one or more of the figures.

### DETAILED DESCRIPTION

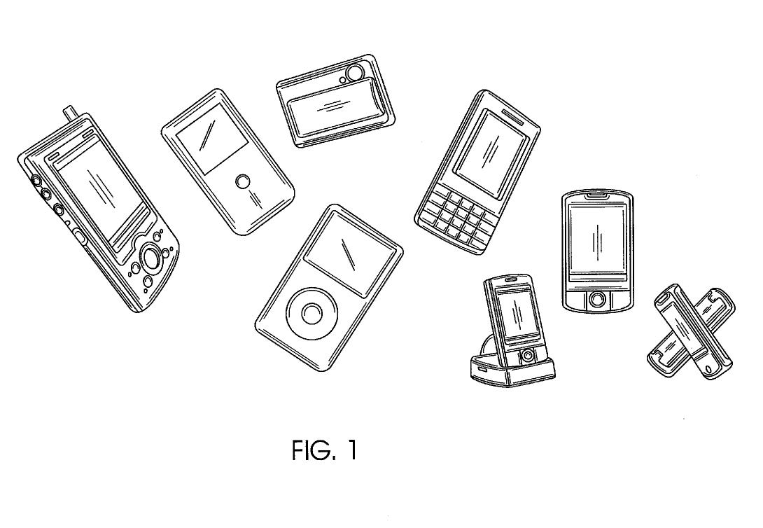

FIG. 1 shows various electronic devices found in the consumer market that may become damaged due to being dropped, hit or from other abuse that may not be covered by a warranty. Such devices include PDAs, cell phones, MP3 players, Ipod®, GPS receivers, calculators, and laptop and notebook computers. It is noteworthy that the devices mentioned are portable, but this is not limiting and the techniques disclosed herein may apply to portable or non-portable devices in accordance with one or more embodiments of the present invention.

The visual damage detection element may be passive, easy to inspect, cost effective, and/or replaceable if the product is repaired. Various locations may be selected for placement of visual damage detection elements. For example, because stress is defined as the force per unit area, and whereas edge and corner locations will have small contact areas upon impact, stress will concentrate at these locations. Therefore, corners and edges may be locations for placement of visual damage detection elements to detect the maximum force concentration due, for example, to dropping the device or other types of events that may cause damage.

For example, the device may be laying flat on a surface and experience a compressive load when, for example, a heavy object is placed or falls on it. Force concentration may then reach sufficient magnitude to damage the device. Locating a visual damage detection element then depends on where such compressive forces will typically concentrate to cause bending or crushing. For example, the display of a portable device may be sensitive to compressive force to the display face, in addition to shock from being dropped on a corner of the device. Therefore, a visual damage detection element may be placed on the flat surface of the device housing near the display.

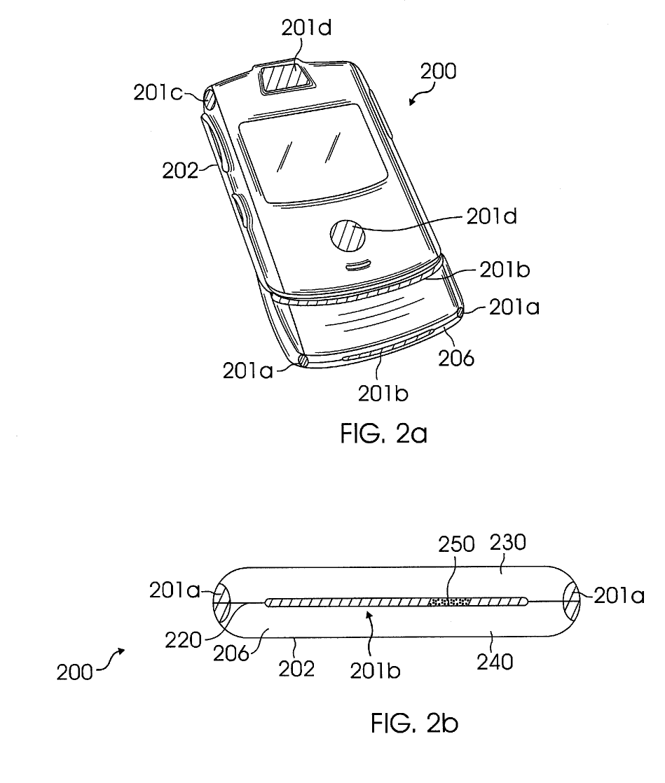

FIGS. 2a and 2b show examples of various locations for placement of one or more visual damage detection elements 201 on a housing 202 of a device 200 (e.g., a cell phone). A location of visual damage detection element 201 may depend on where force (e.g., due to impact or compression) generates the greatest concentration of stresses on contact due to orientation and direction of motion when device 200 is dropped or otherwise abused.

Visual damage detection element 201 may be any desired shape or geometry and made of any type of material (e.g., glass, plastic, resin, or some combination of materials), depending upon the location and design constraints, as discussed further herein. Furthermore, one or more visual damage detection elements 201 may be included as part of device 200 at one or more locations.

For example, visual damage detection element 201 is separately referenced as visual damage detection element 201a, 201b, 201c, and 201d and located on device 200 at corners, edges, hinges, and flat surfaces, respectively, of device 200. Visual damage detection element 201b may be located generally along one or more edges or for example, as shown in FIG. 2b, visual damage detection element 201b may be situated along a seam line 220 between a top half 230 and a bottom half 240 of an edge 206 of housing 202.

In general, visual damage detection element 201 may be located, for example, where the full force of an impact may be concentrated on a small area. Visual damage detection element 201 may provide a visual indication when force exceeding a designed for limit has been exceeded. For example, visual damage detection element 201b in FIG. 2b shows a visual damage indication 250, which is visual change in the appearance of visual damage detection element 201. The visual change may represent a crack, crease, change in color, or other visual effect in accordance with one or more embodiments of the present invention.

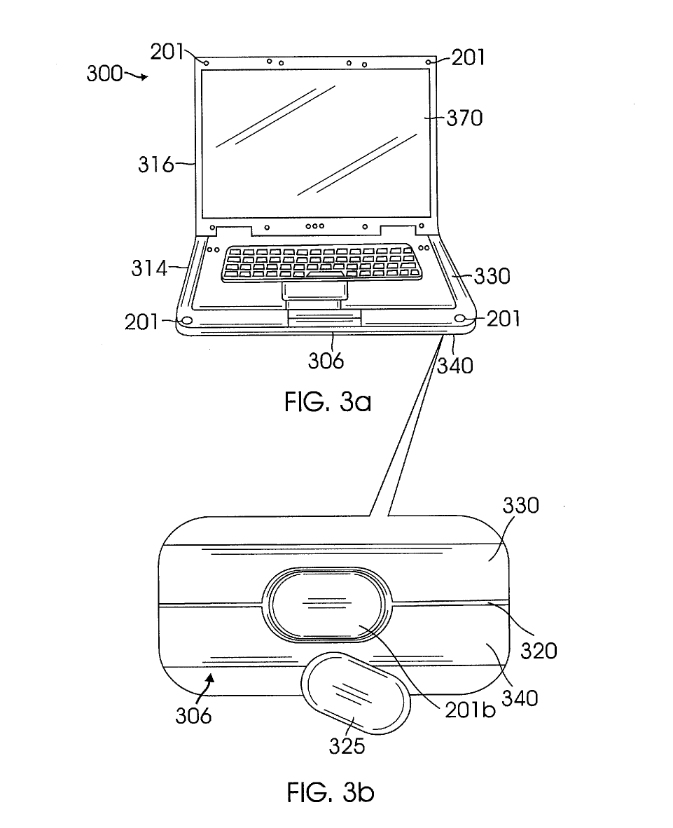

Referring to FIGS. 3a and 3b, a laptop computer 300 may include one or more visual damage detection elements 201 located, for example, at one or more corners of laptop computer 300. Visual damage detection element 201, referenced as visual damage detection element 201b, may be located at one or more edges of laptop computer 300, such as at the edges of a main housing 314 or a display housing 316 for a display 370.

As a specific example, visual damage detection element 201b may be located along an edge 306, such as at a seam line 320 between a top half 330 and a bottom half 340 of main housing 314 (shown in detail in FIG. 3b). This may represent a location where the force (e.g., strain level) may be concentrated when impact or load capable of damage may occur. Furthermore, because of the large surface area of main housing 314 and display housing 316 (e.g., having a cover, keyboard, display, or base), one or more visual damage detection elements 201 may be incorporated on the surface areas of laptop computer 300.

In accordance with one or more embodiments of the present invention, a cover plate 325 may be provided to cover visual damage detection element 201. For example, cover plate 325 may provide protection to visual damage detection element 201. Thus, damage observed in visual damage detection element 201 may be derived from forces (e.g., stresses) transmitted through laptop computer 300, rather than from direct damage exclusively to visual damage detection element 201, by itself. Cover plate 325 may add to the reliability of visual damage detection element 201 as an indicator of damage solely to any device in which it is incorporated. Additionally, cover plate 325 may be of a material substantially identical to that of main housing 314 or display housing 316 of laptop computer 300 to provide continuity of product appearance, if desired.

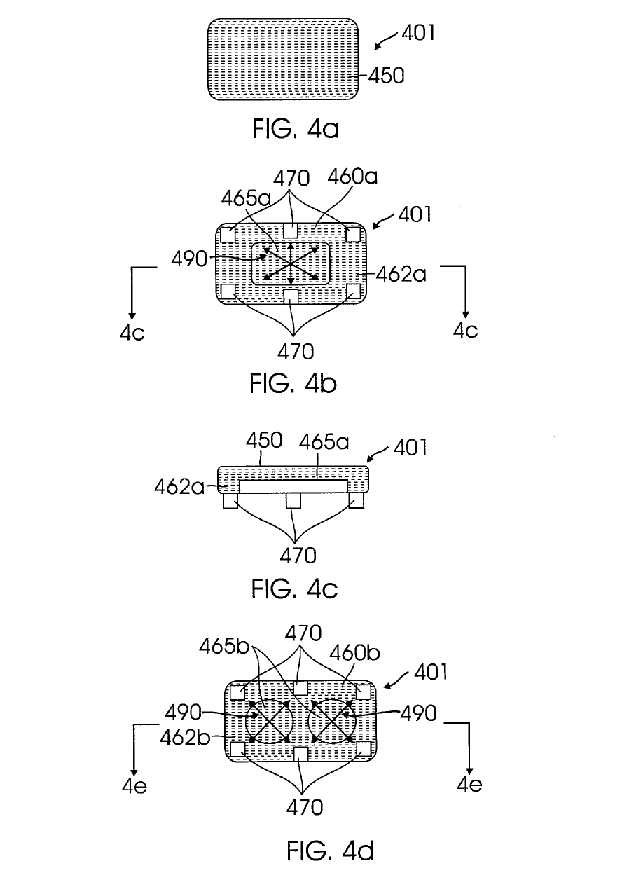

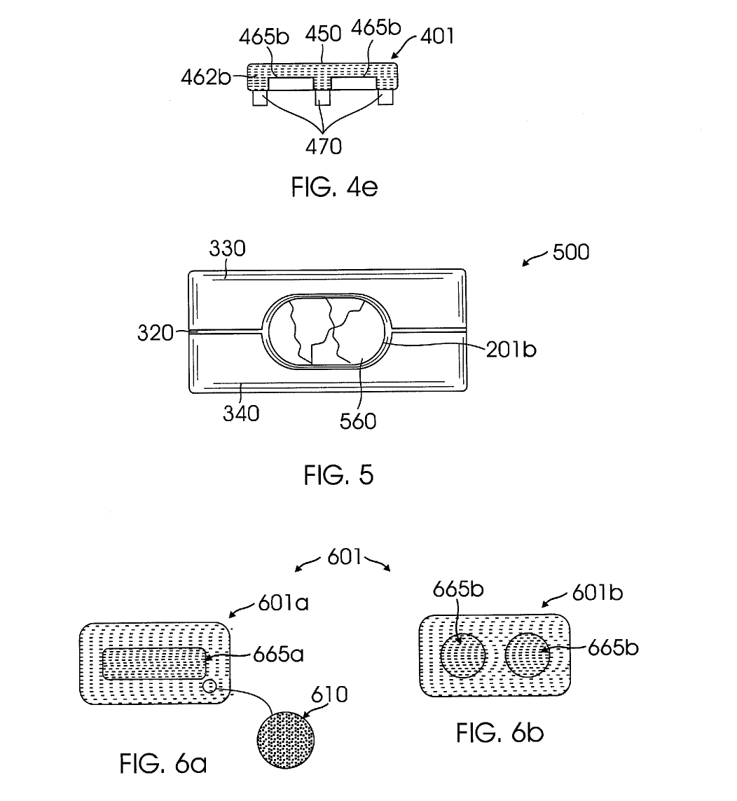

FIGS. 4a-4e show views of specific examples of a visual damage detection element 401 in accordance with one or more embodiments of the invention. Visual damage detection element 401 may be viewed as representing a specific implementation example for visual damage detection element 201 (FIG. 2).

As shown in FIG. 4a, visual damage detection element 401 includes a front 450, which would generally face out externally from a housing of a device (e.g., facing outward from housing 202 of device 200 of FIG. 2). Visual damage detection element 401 may be any desired shape and geometry, such as flat, convex, or concave as may be determined by design considerations, as discussed further herein.

FIG. 4b shows one embodiment of a back 460a of visual damage detection element 401. Back 460a may have a complex surface having two areas, including a periphery 462a and a center 465a. FIG. 4c shows a side view of visual damage detection element 401, which illustrates center 465a having a recessed or thinned structure in accordance with one or more embodiments of the present invention. FIG. 4d shows another embodiment of a back 460b of visual damage detection element 401 having two separate recessed centers 465b, as further shown by the side view in FIG. 4e. As an example, each center 465b may be designed to fail at a different force threshold.

Visual damage detection element 401 may be incorporated, for example, with a housing (e.g., housing 202 of FIG. 2) in various ways. For example in the embodiments shown in FIGS. 4a-4e, visual damage detection element 401 may be provided with one or more tabs 470, which provide for attachment to the housing (e.g., bonding to or insertion into receiving locations on the housing). The detailed design and location of tabs 470 may be part of the integral design of visual damage detection element 401 and the housing of the device to cause forces applied to the housing to transmit into or be felt by visual damage detection element 401 via tabs 470. For example, arrows 490 shown in FIGS. 4b and 4d are examples of where paths of highest stress may occur, such as for example between different combinations of tabs 470 across centers 465a and 465b.

In FIGS. 4b to 4e, tabs 470 are shown extending from visual damage detection element 401, but this is not limiting. For example, tabs 470 may extend from the sides of visual damage detection element 401 rather than (or in addition to) back 460a or 460b. The number and placement of tabs 470 may vary and various other configurations may be implemented, in accordance with embodiments of the present invention as would be understood by one skilled in the art. For example, the thickness and specific contours of tabs 470 may be varied to produce destructive failure when forces transmit via tabs 470 through visual damage detection element 401.

This may be understood, for example, by considering that tabs 470 (e.g., mounting tabs) are the points at which forces may transfer from the housing into visual damage detection element 401. By appropriately contouring the thickness and shape of visual damage detection element 401 and tabs 470, the critical failure path may be designed and the failure limit quantified in the thinnest regions of visual damage detection element 401 using accepted design principals and knowledge of the materials comprising visual damage detection element 401.

Placement of tabs 470 and design of the thickness and contours of visual damage detection element 401 may be related. As shown for example in FIGS. 4b and 4d, arrows 490 indicate paths between tabs 470 which pass directly through the more fragile thin sections of centers 465a and 465b. Thus, arrows 490 indicate possible paths along which the stress is greatest and where failure, such as cracking and creasing, may occur.

The design of visual damage detection element 201 (or visual damage detection element 401), for example, may be accomplished by use of design software, such as for example with ANSYS Mechanical and Multiphysics (by ANSYS, Inc. of Canonsburg, Pa.), which are general purpose finite element modeling packages for numerically solving a wide variety of mechanical problems and incorporate both structural and material properties. With such available methods, a component may be reliably designed to meet specified strength and failure use conditions.

Visual damage detection element 201 may be implemented, for example, based on the type of housing and the particular application and design constraints or specifications. Thus, visual damage detection element 201 may be implemented in various ways and is not limited as discussed for example in reference to FIGS. 4a-4e or other embodiments. For example, visual damage detection element 201 may include a ribbed structure to provide for an induced “crumpling” under load or designed based on expected directions of force (e.g., high stress) in the housing (e.g., when dropped or otherwise abused).

For example, visual damage detection element 201 may be implemented without tabs 470, but rather be formed as part of the housing or incorporated as part of the housing during the manufacturing process for the particular device. For example, visual damage detection element 201 may have a shape and contour to form part of the housing (e.g., under a compressive pre-load to within a specified tolerance) and function to provide a visual damage indication as discussed herein. This may be accomplished, for example, by placing visual damage detection element 201 in a location of a seam line (e.g., seam line 320) between two halves of the housing during assembly. Exceeding the maximum allowed tolerance pre-load by a specified additional amount of force may produce the level of stress that leads to failure of visual damage detection element 201.

FIG. 5 shows a portion of a housing 500, which includes visual damage detection element 201b in accordance with an embodiment of the present invention. Visual damage detection element 201b is shown providing an example of visible damage evidence 560 (e.g., cracks, creases, and/or discoloration) after a force to housing 500 exceeding a certain threshold has occurred. It should be understood that if more than one visual damage detection element 201 is included as part of housing 500, for example, not all visual damage detection elements 201 may show damage, but a visible damage indication by at least one visual damage detection element 201 may indicate that a force was applied to housing 500 that exceeded the manufacturer's warranty coverage. Consequently, this would give the manufacturer some financial protection against liability for a product due to overly abusive treatment.

In accordance with an embodiment of the present invention, visual damage detection element 201 may be provided with color coding to indicate what level of force (or abuse) the device is expected to withstand, beyond which visual damage detection element 201 would be expected to destructively fail or otherwise provide a visible damage indication. As an example, visual damage detection elements 201 may be color coded to provide an indication to a consumer of the ruggedness of the device incorporating visual damage detection element 201. Thus, visual damage detection elements 201 may be provided in different color codes (e.g., red, blue, green, and yellow) to indicate different degrees of impact capability for the particular corresponding product, for example, that would fall within warranty coverage.

As a specific example, one product may be determined to withstand a maximum stress when dropped on certain edges or corners. For this maximum limit, visual damage detection element 201 may be designed to fail above that level and may be supplied in a color according to that level and incorporated into the product. A device built to withstand a different level of maximum stress when dropped or abused at different locations on the device may have visual damage detection elements 201 with different colors in different locations on that device. Thus, manufacturers may obtain visual damage detection elements 201 designed to show by a visible indication (e.g., visible damage evidence 560) when forces applied to the product have exceeded a given allowable limit. Color coding may be implemented by selecting different spectral colors and combinations of colors as, for example, by using multicolored stripes. Alternatively, visual damage detection element 201 may be provided with a damage limit indication in print or bar code format (e.g., on front 450).

In accordance with another embodiment of the present invention, FIG. 6 shows a visual damage detection element 601 that includes a dispersed amount of beads 610 (e.g., microscopic beads). Visual damage detection element 601 may be viewed as representing a specific embodiment of visual damage detection element 201.

Beads 610 may include encapsulating bodies or may themselves be bodies composed mainly of a material such that, when the stress field in visual damage detection element 601 exceeds a specified limit, beads 610 may rupture or fail and release a material that causes the appearance of visual damage detection element 601 to change (e.g., in color or transparency). This may occur through the release of a dye or chemical, for example, or through physical or chemical interaction between the chemical and one or more of the components of the material of which visual damage detection element 601 is composed.

FIG. 6a shows visual damage detection element 601 (labeled and referenced as visual damage detection element 601a), which corresponds generally to the structure of visual damage detector element 401 of FIGS. 4b-4c. Visual damage detection element 601a illustrates what visible damage may look like in visual damage detection element 601a containing micro-beads 610 after a sufficient level of impact damage to the housing incorporating visual damage detection element 601a. For example, a center 665a may be thinner and show the visible damage indication, due to excessive stress in this area, by a change of appearance of center 665a (relative to the remaining portions of visual damage detection element 601a).

Similarly, FIG. 6b shows visual damage detection element 601 (labeled and referenced as visual damage detection element 601b), which corresponds generally to the structure of visual damage detector element 401 of FIGS. 4d-4e. Visual damage detection element 601a illustrates what visual damage may look like in visual damage detection element 601a containing micro-beads 610 after a sufficient level of impact damage to the housing incorporating visual damage detection element 601b. For example, a center 665b (e.g., corresponding to centers 465b of FIGS. 4d-4e) may be thinner and show the visible damage indication, due to excessive stress in this area, by a change of appearance of center 665b (relative to the remaining portions of visual damage detection element 601b).

In a further embodiment, beads 610 incorporated within visual damage detection element 601 may further have differing details of structure and failure level, which release differing dyes or differing interactive chemicals, which may produce different visible effects (e.g., color changes corresponding to different levels of stress failure). This enables the merchant or manufacturer to determine by visual inspection a quantitative measure of the stress that resulted in product failure. This embodiment may be used also, if desired, to span both various ranges of covered warranty damages as well as damage exceeding all warranty limits.

Embodiments described above illustrate but do not limit the invention. It should also be understood that numerous modifications and variations are possible in accordance with the principles of the present invention. Accordingly, the scope of the invention is defined only by the following claims.

What is claimed is:

1. A device comprising:
a housing; and
a visual damage detection element, coupled to the housing, adapted to provide a visual indication if the housing is subjected to a force greater than a first threshold.

2. The device of claim 1, wherein the visual damage detection element is formed as part of the housing.

3. The device of claim 1, further comprising a plurality of the visual damage detection elements incorporated into the housing at a corner, an edge, and/or a surface of the housing.

4. The device of claim 1, wherein the visual damage detection element is incorporated into the housing at a seam line.

5. The device of claim 1, wherein the visual damage detection element is incorporated into the housing subject to a preload stress when the housing was assembled, wherein the first threshold is greater than the preload stress.

6. The device of claim 1, wherein the visual damage detection element further comprises one or more mounting tabs adapted to couple to the housing and transmit stress applied to the housing to the visual damage detection element.

7. The device of claim 1, wherein the visual damage detection element is comprised of a material configured to fail when the force is greater than the first threshold.

8. The device of claim 1, wherein the visual damage detection element further comprises a first area and a second area adapted to provide corresponding visual indications if the housing is subjected to forces greater than the first threshold and a second threshold, respectively.

9. The device of claim 1, wherein the visual indication comprises a visible crack and/or a discoloration.

10. The device of claim 1, wherein the visual damage detection element further comprises beads adapted to provide the visual indication.

11. The device of claim 1, wherein the visual damage detection element further comprises a first plurality of beads and a second plurality of beads adapted to provide corresponding visual indications if the housing is subjected to forces greater than the first threshold and a second threshold, respectively.

12. The device of claim 1, further comprising a cover adapted to protect the visual damage detection element from damage directly solely to the visual damage detection element

13. A device comprising:
a housing; and
means for providing a visual indication if the housing is subjected to a force greater than a first threshold.

14. The device of claim 13, wherein the providing means is located at more than one location on the housing.

15. The device of claim 13, wherein a pre-load stress is applied to the providing means during assembly of the housing.

16. The device of claim 13, wherein a color of the providing means corresponds to the first threshold.

17. The device of claim 13, wherein the providing means further provides a visual indication if the housing is subjected to a force greater than a second threshold, wherein the second threshold is greater than the first threshold.

18. A method comprising:
providing a housing for a device;
selecting a visual damage detection element based on a level of force that may be applied to the device; and
coupling the visual damage detection element to the housing during assembly of the device.

19. The method of claim 18, wherein the visual damage detection element is color coded to indicate a level of force above which applied to the device results in the visual damage detection element changing its appearance.

20. A method comprising:
inspecting a visual damage detection element of a device, wherein the visual damage detection element provides a visual indication if the device is subjected to a force greater than a certain level; and
determining if the device was subjected to a force greater than the certain level based upon the inspecting.

21. The method of claim 20, wherein the visual indication comprises at least one of a crack and a change in color.

22. The method of claim 20, wherein the visual damage detection element comprises a plurality of beads.

23. The method of claim 20, wherein the visual damage detection element provides another visual indication if the device is subjected to a force at another level greater than the certain level.

24. The method of claim 20, further comprising removing a cover to perform the inspecting.
